(19) United States
(12) Patent Application Publication
(10) Pub. No.: US 2026/0220572 A1
(43) Pub. Date: Jul. 30, 2026

(54) RESOURCE OPTIMIZATION PLATFORM FOR DOCUMENT MANAGEMENT SYSTEM AND METHOD

(71) Applicant: Kyocera Document Solutions Inc., Osaka (JP)

(72) Inventor: Selim ZAMAN, San Mateo, CA (US)

(73) Assignee: Kyocera Document Solutions Inc., Osaka (JP)

(21) Appl. No.: 19/040,983

(22) Filed: Jan. 30, 2025

(51) Int. Cl. G06Q 10/0631; G06Q 30/0201

(52) U.S. Cl. CPC G06Q 10/06315; G06Q 30/0201

(57) ABSTRACT

A document management system includes a customer intelligence platform that collects customer market data for customers of the document management system to generate recommendations for actions to be taken on behalf of each customer. The customer market data includes customer characteristics, an engagement status, and a usage pattern of the customer. Analysis is done of the customer market data to generate a baseline heuristics assessment that includes a cyclicality factor having a probability score and a seasonality factor having a probability score. This data is applied to a predictive heuristics model to generate a plurality of actions. A price optimization model is applied to the plurality of actions along with the customer market data to identify an action, such as a resource utilization or allocation, and to determine whether the action should be taken based on a score for the action and a threshold.

### FIELD OF THE INVENTION

The present invention relates to using a customer service intelligence platform to manage customers and plans of a document management system. More particularly, the present invention relates to using a customer service intelligence platform as a resource optimization platform in the document management system.

### DESCRIPTION OF THE RELATED ART

Subscription plans for software services may fall in two categories. One category may be monthly or annual subscription plans. Another category may be usage-based subscription plans, also known as pay-as-you-go (PAYG) plans. Usage-based subscription plans may have a fixed annual or monthly price component to cover for fixed costs in maintaining the user. PAYG plans work best for user who only occasionally use the service as at a low level. This scheme may work against these users in the event they suddenly need to increase usage levels, usually before these users have a chance to do a cost benefit analysis between PAYG and other subscriber plans.

For service providers, PAYG plans may hurt profitability because, without any prior knowledge of the customer, the provider allocates or procures cloud resources for each newly provisioned user. PAYG also may require that the service provider maintain a minimum level of resources in an ongoing manner. If there are many PAYG plan subscribers with low levels of usage, then the average cost of servicing these customers reduces profitability.

PAYG plans work well in industries like telecom or utilities where idle bandwidth in the service delivery pipeline provides low marginal cost of adding new PAYG customers. In cloud services, however, the marginal cost of adding a new user is higher due to specific memory resources required to provide the service in a multi-tenant service architecture.

### SUMMARY OF THE INVENTION

A method for managing customers accessing a customer service intelligence platform of a document management system is disclosed. The method includes collecting customer data for a customer account within the document management system. The customer data includes a set of customer characteristics, an engagement status of the customer, and at least one usage pattern of the customer. The method also includes analyzing the customer data to generate a baseline heuristics assessment that includes at least one cyclicality factor and at least one seasonality factor. Each of the at least one cyclicality factor is assigned a probability score and each of the at least one seasonality factor is assigned a probability score. The method also includes applying a predictive heuristics model to the baseline heuristics assessment, the probability score of the at least one cyclicality factor, and the probability score of the at least one seasonality factor to identify or generate a plurality of resource utilizations applicable to the customer account. Each of the plurality of resource utilizations is assigned a probability score. The method also includes applying a resource optimization model to the plurality of document management services from the predictive heuristics model and the customer data collected within the document management system to identify or select a resource utilization to provide to the customer account. The resource utilization is assigned a score by the service optimization model. The method also includes determining whether the score for the resource utilization is equal to or greater than a defined threshold for the customer account. The method also includes recommending through the document management system that the resource utilization be offered to the customer account.

In some embodiments, the resource utilization may include a cloud resource utilization for the customer account. The resource utilization may include a forecasted level of service. In some embodiments, applying the predictive heuristics model may include assigning a weight to each of the at least one cyclicality factor and a weight to each of the at least one seasonality factor. In some embodiments, the predictive heuristics model is a weighted linear regression model to generate a probability curve.

In some embodiments, the method also includes using a cyclicality analysis module to generate the at least one cyclicality factor. In other embodiments, the method also includes using a seasonality analysis module to generate the at least one seasonality factor.

A customer service intelligence platform of a document management system is disclosed. The platform includes a processor and a memory connected to the processor. The memory stores instructions that, when executed on the processor, configures the platform to perform operations. The operations include collecting customer data for a customer account within the document management system. The customer data includes a set of customer characteristics, an engagement status of the customer, and at least one usage pattern of the customer. The operations also include analyzing the customer data to generate a baseline heuristics assessment that includes at least one cyclicality factor and at least one seasonality factor. Each of the at least one cyclicality factor is assigned a probability score and each of the at least one seasonality factor is assigned a probability score. The operations also include applying a predictive heuristics model to the baseline heuristic assessment, the probability score of the at least one cyclicality factor, and the probability score of the at least one seasonality factor to identify or generate a plurality of resource utilizations applicable to the customer account. Each of the plurality of resource utilizations is assigned a probability score. The operations also include applying a resource optimization model to the plurality of resource utilizations from the predictive heuristics model and the customer data collected within the document management system to identify or select a resource utilization to provide to the customer account. The resource utilization is assigned a score by the resource optimization model. The operations also include determining whether the score for the resource utilization is equal to or greater than a defined threshold for the customer account. The operations also include recommending through the document management system that the resource utilization be offered to the customer account.

In some embodiments, the resource utilization may include a cloud resource utilization for the customer account. The resource utilization may include a forecasted level of service. In some embodiments, the operation of applying the predictive heuristics model may include assigning a weight to each of the at least one cyclicality factor and a weight to each of the at least one seasonality factor. In some embodiments, the predictive heuristics model is a weighted linear regression model to generate a probability curve.

In some embodiments, the platform also includes a cyclicality analysis module to generate the at least one cyclicality factor. In other embodiments, the platform also includes a seasonality analysis module to generate the at least one seasonality factor.

A non-transitory computer-readable medium having stored thereon processor-executable instructions for performing operations is disclosed. The operations include collecting customer data for a customer account within the document management system. The customer data includes a set of customer characteristics, an engagement status of the customer, and at least one usage pattern of the customer. The operations also include analyzing the customer data to generate a baseline heuristics assessment that includes at least one cyclicality factor and at least one seasonality factor. Each of the at least one cyclicality factor is assigned a probability score and each of the at least one seasonality factor is assigned a probability score. The operations also include applying a predictive heuristics model to the baseline heuristic assessment, the probability score of the at least one cyclicality factor, and the probability score of the at least one seasonality factor to identify or generate a plurality of resource utilizations applicable to the customer account. Each of the plurality of resource utilizations is assigned a probability score. The operations also include applying a resource optimization model to the plurality of resource utilizations from the predictive heuristics model and the customer data collected within the document management system to identify or select a resource utilization to provide to the customer account. The resource utilization is assigned a score by the resource optimization model. The operations also include determining whether the score for the resource utilization is equal to or greater than a defined threshold for the customer account. The operations also include recommending through the document management system that the resource utilization be offered to the customer account.

In some embodiments, the resource utilization may include a cloud resource utilization for the customer account. The resource utilization may include a forecasted level of service. In some embodiments, applying the predictive heuristics model may include assigning a weight to each of the at least one cyclicality factor and a weight to each of the at least one seasonality factor. In some embodiments, the predictive heuristics model is a weighted linear regression model to generate a probability curve.

In some embodiments, the operations also include using a cyclicality analysis module to generate the at least one cyclicality factor. In other embodiments, the operations also include using a seasonality analysis module to generate the at least one seasonality factor.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, numerous variations are possible. For instance, structural elements and process steps may be rearranged, combined, distributed, eliminated, or otherwise changed, while remaining with the scope of the disclosed embodiments.

### BRIEF DESCRIPTION OF THE DRAWINGS

Various other features and attendant advantages of the present invention will be more fully appreciated when considered in conjunction with the accompanying drawings.

FIG. 1 illustrates a block diagram of a document management system according to the disclosed embodiments.

FIG. 2 illustrates an OCR device according to the disclosed embodiments.

FIG. 3 illustrates a block diagram of a customer intelligence platform for the document management system according to the disclosed embodiments.

FIG. 4 illustrates a block diagram of a customer intelligence layer of the customer intelligence platform according to the disclosed embodiments.

FIG. 5A illustrates a table of example customer characteristics according to the disclosed embodiments.

FIG. 5B illustrates a table of example levels of engagement according to the disclosed embodiments.

FIG. 5C illustrates a table of example usage metrics and patterns according to the disclosed embodiments.

FIG. 6 illustrates a block diagram of a data analysis layer of the customer intelligence platform according to the disclosed embodiments.

FIG. 7 illustrates a table of an example baseline heuristic assessment according to the disclosed embodiments.

FIG. 8 illustrates a block diagram of a predictive analytics layer of the customer intelligence platform according to the disclosed embodiments.

FIG. 9 illustrates a table of a predictive heuristic assessment having attributes and probability scores according to the disclosed embodiments.

FIG. 10 illustrates a table of the strategy identification having strategies and results according to the disclosed embodiments.

FIG. 11 illustrates a block diagram of a recommendations layer of the customer intelligence platform according to the disclosed embodiments.

FIG. 12 illustrates a block diagram of a supervised learning pipeline for a model as used by the predictive analytics layer according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

In some embodiments, prior knowledge of industry seasonality patterns and customer specific cyclicality patterns derived from usage metrics allows the service provide to dynamically allocate cloud resources to optimize costs while keeping the option of rapid auto-scaling in case of an unanticipated usage spike. Resources may be allocated, or scaled, up or down. By reducing the resource cost for low level users, the service provider may optimize the pricing plan, such as reducing the PAYG price or lower, or even remove, the fixed price component.

In this manner, the price point works out better for both users and service providers. Users may pay less and can be shown how and why in periodic reports. Service providers may improve the overall profitability and competitive position in the market by lowering the price point even as revenue per user may go down in absolute terms. Over time, the cloud resource allocation may be continually adjusted to improve profitability through cost or price modeling and optimization.

The disclosed embodiments may harness usage metrics, compare them with industry trends or data, and apply a statistical analysis, such as a weighted linear regression analysis, to determine the probability forecast of resource utilization per customer, or tenant. A predictive heuristic model may be used to generate a weighted probability distribution curve that may be used to derive the best prediction for a resource utilization forecast.

Subscription and pricing plan optimization may be done at an overall tenancy level including all cloud information or document management features. They also can be granulated in terms of specific features and storage plans. Cloud resources are allocated optimally to satisfy the forecasted resource demands of the usage level. The disclosed embodiments optimize customer subscription levels and pricing plans for various cloud information management features by providing automatic monitoring and execution of business growth opportunities. Another benefit may be cloud resource optimization to provide the forecasted level services.

An integrated customer intelligence platform is disclosed that is scalable and configurable for a wide variety of customers. The platform also may be automated through intelligent processing of existing customer data to generate an optimum subscription and pricing plan. These features, as well as optimum cloud resources allocation, that result in win-win cost/benefits outcome for both the customer and the service provider.

Specifically, the platform may provide a statistical assessment of probability of existing customers'cloud resources utilization based on customer knowledge and usage data. It also may provide an application of predictive heuristics to forecast optimal subscription plans and price points. It further may provide an application of predictive heuristics to allocate optimal cloud resources in accordance with the usage forecast.

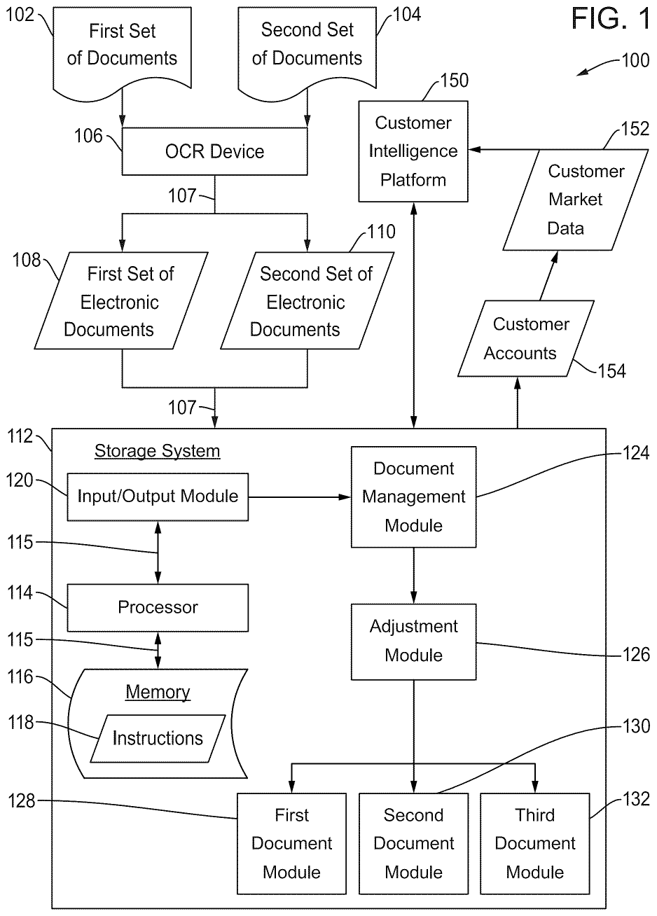

FIG. 1 depicts a block diagram of a document management system 100 according to the disclosed embodiments. Document management system 100 may receive large batches of documents, processing them, and manage their access and use in operations. As part of this, document management system 100 uses storage system 112 that stores documents which have been received and processed within system 100. One feature of the processing may be scanning or importing batches of documents by optical character recognition (OCR) device 106.

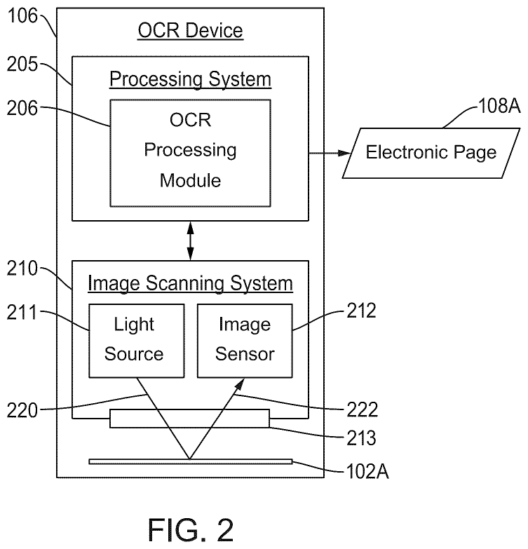

OCR device 106 is communicatively coupled to storage system 112 within system 100. OCR device 106 may be connected to storage system 112 over a network 107. OCR device 106 may be within a printing device, a scanner, a computing device, and the like. OCR device 106 is disclosed in greater detail below by FIG. 2. Within system 100, OCR device 106 helps with the importation of large batches of documents, such as records, books/texts, forms, or other data that is in a document that is captured electronically to be managed using storage system 112.

For example, a first set of documents 102 may be medical records dating back to 1984. Many of these records are on paper and in different formats. OCR device 106 captures images of the records to generate a first set of electronic documents 108. First set of electronic documents 108 are the electronic or image versions of first set of documents 102. First set of electronic documents 108 may be images having pixels to represent the characters and graphics within first set of documents 102. OCR device 106 imports first set of documents 102 into system 100 by processing them.

Using the above example, a second set of documents 104 also may be imported into system 100 using OCR device 106. Second set of documents 104 may be company records kept on paper for the past several years. These records also may include different formats and even different languages. OCR device 106 captures second set of documents 104 to generate a second set of electronic documents 110. Second set of electronic documents 110 also may be images having pixels that represent the characters and graphics within second set of documents 104.

First set of documents 102 is provided to storage system 112. Storage system 112 performs pre-processing of the documents before storing them within a document module. Storage system 112, however, includes a processor 114 that executes instructions to configure the storage system to perform specified functions. Processor 104 is connected to memory storage 116 by data bus 115. Memory storage 116 includes instructions 118. Instructions 118 may be code that, when read by processor 114, configures storage system 112 to perform the operations disclosed herein.

Processor 114 also may be coupled to input/output module 120 for storage system 112. Electronic documents may be imported from OCR device 106 at input/output module 120 over network 104. In some embodiments, storage system 112 and OCR device 106 may be in the same device such that network 107 and input/output module 120 are not used. Upon receipt of the electronic documents, processor 114 executes instructions 118 to configure storage system 112 to perform document management operations.

These operations may include processing a set of electronic documents, such as first set of electronic documents 108, using a document management module 124. Document management module 124 may receive documents within storage system 112 and determine how to handle them. For example, various criteria may be provided to document management module 124 to sort or classify the incoming documents. Example of the criteria may be project, author, unique identification number, company, date, size, and the like. Document management module 124 may assign each document to one of a plurality of document modules within storage system 112.

Adjustment module 126 may adjust documents classified by document management module 124. Different fields, such as dates, may be adjusted. In some embodiments, other criteria may be defined to prompt the adjustment of the original electronic document received at storage system 112. For example, personal information may be redacted from documents before being stored in a document module.

Both sets of electronic documents are stored within storage system 112. Thus, first set of electronic documents 108, as well as any modified electronic versions of the documents, are stored at a document module, or storage. Storage system 112 may include first document module 128, second document module 130, and third document module 132. First document module 128 may store the processed and modified versions of first set of electronic documents 108. Second document module 130 may store the processed and modified versions of second set electronic documents 110. Third document module 132 may include the original versions of the electronic documents only. Each document module may include its own rules and management functions for the corresponding documents.

Document management system 100 also includes customer intelligence platform 150. Customer intelligence platform 150 also may be known as a customer service intelligence platform. Customer intelligence platform 150 may perform customer relationship management within system 100. Customer intelligence platform 150 collects customer market data 152 from various customer accounts 154 within system 100. Customers having customer accounts 154 interact within system 100, such as interacting with storage system 112 to retrieve documents from one of the storage modules. Customers also upload documents using OCR device 106. All of these actions result in customer market data 152.

Customer market data 152 may be data and actions tracked for a specific customer account of customer accounts 154. For example, as customers use system 100 and purchase service or products within system 100, customer intelligence platform 150 may track this information. Customer market data 152 may be provided real-time to platform 150, or may be provided to the platform using periodic updates. Customer accounts 154 may keep track of actions and purchases, then provide this information to customer intelligence platform 150. In some embodiments, customer market data 152 includes customer characteristics, an engagement status, and one or more usage patterns for each customer account. These features are disclosed in greater detail below.

Customer intelligence platform 150 uses customer market data 152 to recommend that one or more actions be taken within system 100 with regards to the corresponding customer account. Customer intelligence platform 150 may implement heuristics and predictive analytic modules to provide these recommendations. These recommendations include identifying or recommending a document management service for customers to use document management system 100.

As noted above, users of document management system 100 may use different payment plans to access and use the document management system. Document management system 100 may be considered a service provider that provides subscription plans or PAYG plans to customers. Also noted above are the deficiencies in these plans. Thus, customer intelligence platform 150 may provide recommendations on which plan to propose to a customer along with a price point or other information tailored to the customer. Using these results of the disclosed embodiments, the provider of document management system 100 may allocate cloud resources in a preferred or optimal manner. Customer intelligence platform 150 uses predictive heuristics to determine a price point and plan that better suits users and service providers.

FIG. 2 depicts OCR device 106 according to the disclosed embodiments. OCR device 106 receives a page or document 102A of first set of documents 102. Further pages may be loaded after processing of page 102A is complete. OCR device 106 includes an image scanning system 210 communicatively coupled to a processing system 205 via a communications link 207. Communications link 207 may be a wire, a communications cable, a wireless link, or a metal track on a printed circuit board.

Image scanning system 210 includes a light source 211 that projects light 220 through a transparent window 213 to strike a surface of page 102A. Page 102A, which may be a sheet of paper containing text or graphics, reflects light 220 towards an image sensor 212. Image sensor 212 contains light sensing elements, such as photodiodes or photocells, converts received light 222 into electrical signals that are transmitted to OCR processing module 206 within processing system 205. The electrical signals may be digital bits.

Processing system 205 generates electronic page 108A from the captured data for page 102A. Electronic page 108A is included in one of the electronic documents within first set of electronic documents 108. In some embodiments, OCR device 106 is a slot scanner incorporating a linear array of photocells. OCR processing module 206 that is a part of processing system 205 may be used to operate upon the electrical signals for performing optical character recognition of text and graphics printed on page 102A.

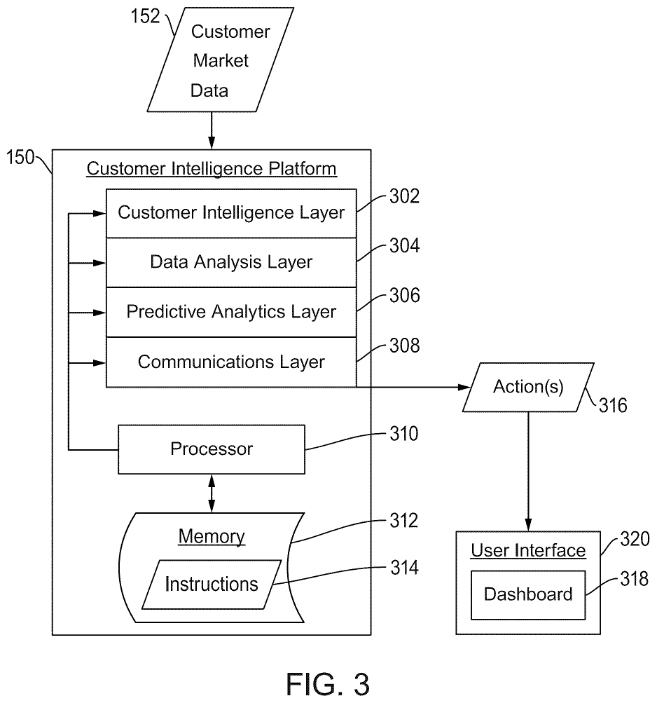

FIG. 3 depicts a block diagram of customer intelligence platform 150 according to the disclosed embodiments. Customer intelligence platform 150 may receive customer market data 152 corresponding to customer accounts 154 and provide actions 316 that may be taken towards the customers to identify subscription and pricing plan optimization within system 100. For example, customer intelligence platform 150 may optimize customer subscription levels for various document management features by providing recommendations for subscription levels and pricing plans for users of document management system 100 in the form of actions 316.

Customer intelligence platform 150 may include a customer intelligence layer 302, a data analytics layer 304, a predictive analytics layer 306, and a communication layer 308. Customer intelligence platform 150 may be a cloud-based platform in that it is accessible over network 107 to exchange data and services with other components within system 100. Processor 310 may execute instructions 314 stored in memory 312 to implement the layers of customer intelligence platform 150. Processor 310 is configured by instructions 314 to execute the features disclosed herein. In some embodiments, a different processor 310 may be used for each layer. Alternatively, each layer includes its own components that are implemented by its respective processor 310 and instructions 314.

Customer market data 152 include customer characteristics that are analyzed by customer intelligence platform 150. These customer characteristics may include the following: general characteristics of a typical customer in a specific industry, engagement status of specific customers to determine loyalty and risk of turnover, the number of documents stored in different document classes, such as document modules 128, 130, and 132, the rates at which new documents are uploaded, such as first set of documents 102 and second set of documents 104, the number of documents retained for a longer term, the number of active users in proportion to the total account holders who use document management system 100, the frequency of use of specialty features such as e-signature and retention, cyclical patterns of use, seasonal patterns of use, storage size and statistics, and the like.

The layers of customer intelligence platform 150 may determine statistically the probability of customer likelihood to expand engagement within document management system 100. The disclosed embodiments may determine how likely a customer is to increase storage size, to increase the number of accounts, to sign up for new features, to increase business across geographic locations, to sign up for long term contracts, to benefit from other document solutions offerings, to quit, and the like.

Customer intelligence platform 150 is an integrated customer intelligence platform that is scalable and configurable for a wide range of customer accounts 154. The processes implemented on customer intelligence platform 150 may be automated through intelligent processing of existing customer data. Using the disclosed embodiments, a statistical assessment is provided for the best subscription plan and pricing plan for a customer of document management system 100. The disclosed embodiments also provide the application of predictive heuristics to determine the optimum plans for customers.

Customer intelligence platform 150 accomplishes the tasks of data gathering, statistical analysis, sales guidance generation based on predictive heuristics, updating cloud resources and communicating to the customers on proposed optimized pricing plans, and presenting messages of actions 316 to a targeted customer. Customer intelligence platform 150 includes customer intelligence layer 302. Customer intelligence layer 302 is the data gathering layer. Customer market data 152, or market intelligence data, may be gathered or provided to customer intelligence layer 302 from components within system 100. For example, customer accounts 154 may provide this data. Customer market data 152 includes customer characteristics, engagement status, and usage patterns for respective customer accounts. The customer characteristics, engagement status, and usage patterns should different between customers. These features are disclosed in greater detail below.

Data analysis layer 304 analyzes the customer intelligence data of customer market data 152. Data analysis layer 304 also considers the cyclicality and seasonality of the respective customer and industry. This layer may implement a baseline heuristics assessment and generate one or more cyclicality factors as well as one or more seasonality factors. The output of data analysis layer 304 is actionable intelligence information that may be used to generate recommendations.

Predictive analysis layer 306 receives the actionable intelligence information from data analysis layer 304. Predictive analysis layer 306 introduces intelligent processing of this information to generate the best price point for the customer based on a probabilistic determination of price elasticity and forecasted resource utilization level for document management system 100. This layer also predicts if there is a decline in usage and a possibility of losing a customer of customer accounts 154. These features assist customer relationship management by providing specific retention incentives that the customer may appreciate. Predictive analysis layer 306 uses predictive heuristics, price optimization, and resource optimization with regard to targeted customers to the best price point for each. The disclosed embodiments also may provide a specific communication mechanism to handle each customer.

Communication layer 308 provides the communication pathway to the customer of a customer account 154 and the service provider of document management system 100. Communication layer 308 may act as a presentation layer for the recommendations, or actions 316, generated from predictive analytics layer 306. Communication from recommendations layer may be a combination of email or pop-up messages within system 100. A dashboard 318 also may be provided to the users in a user interface 320 within system 100. Dashboard 318 may display actions 316 to be taken regarding the specific customer accounts. Dashboard 318 may include a tenant dashboard and a sales dashboard, as disclosed in greater detail below.

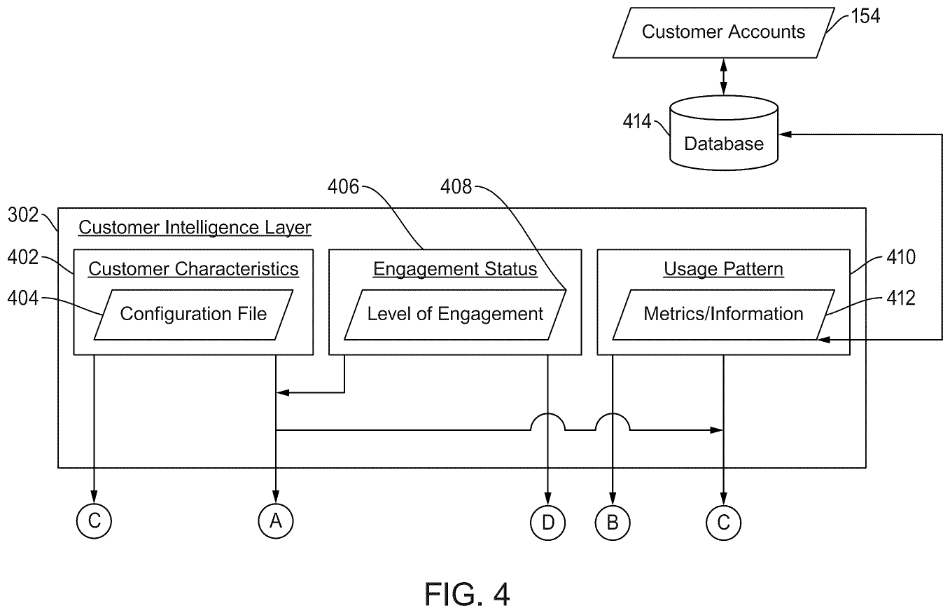

FIG. 4 depicts a block diagram of customer intelligence layer 302 of customer intelligence platform 150 according to the disclosed embodiments. As disclosed above, customer intelligence layer 302 is the data gathering layer of customer intelligence platform 150.

Customer intelligence layer 302 may include three modules, customer characteristics 402, engagement status 406, and usage pattern 410. Customer market data 152 may be provided to customer intelligence layer 302 that provides the information needed for the modules contained therein. These modules may generate output based on customer market data 152 that is passed to modules or components within data analysis layer 304 and predictive analytics layer 306.

Customer characteristics 402 includes a configuration file 404 that is updated during customer onboarding and when customer information changes within document management system 100. The objective of profiling the customer of a customer account 154 based on characteristics is to derive initial heuristics around purchase behavior for a business customer. The initial heuristics may be based on trends of other customers holding a similar profile in the same industry sector.

Configuration file 404 may include information regarding ownership of the entity associated with the respective customer account 154. It also may include the geographical spread or locations of the customer. As document management system 100 may be cloud-based, the customer may access the system from many different locations. Configuration file 404 also may include the size of the organization and the number of users with the customer. Other information includes cyclicality of the business and the seasonality of the business.

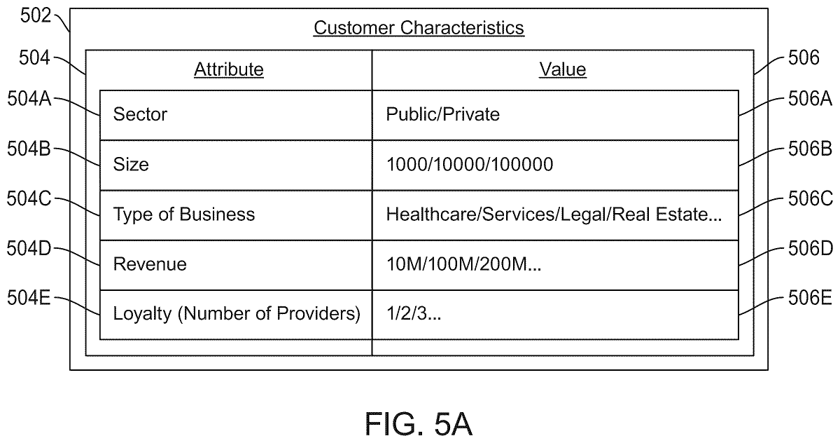

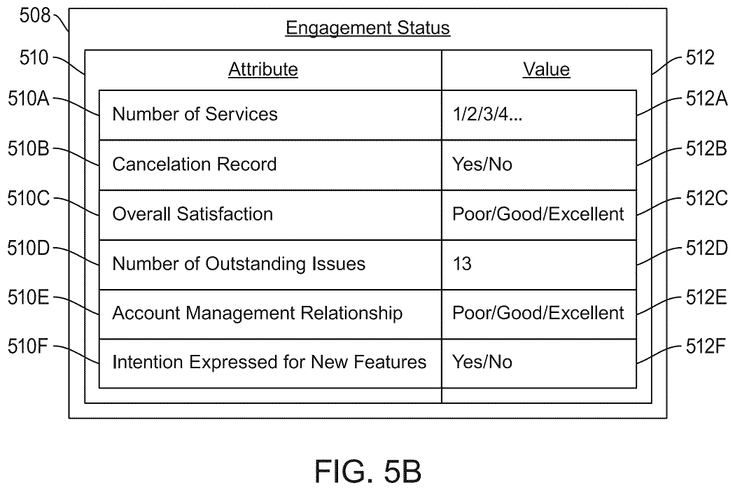

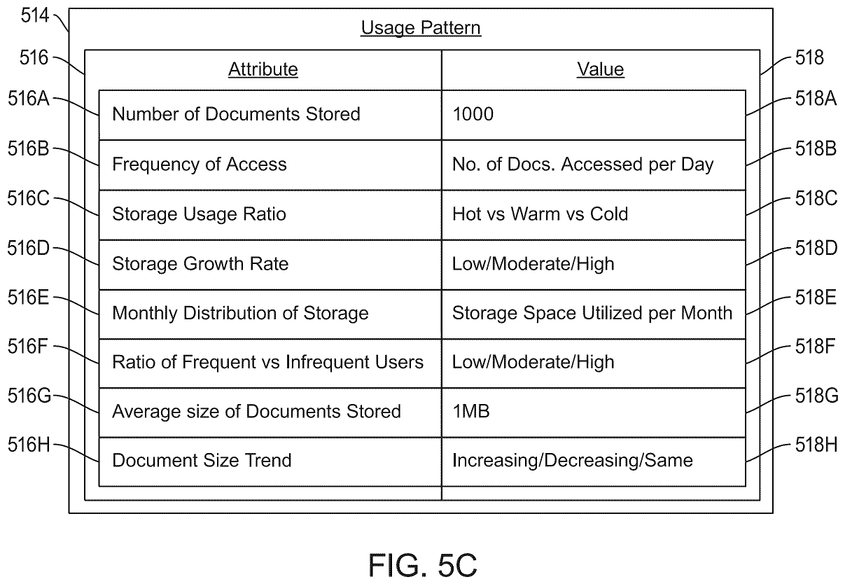

Referring to FIG. 5A, a table 502 of example customer characteristics is disclosed. Table 502 includes attributes 504 and values 506. Customer characteristics 502 may include attributes 504 and values 506 for each customer account. As disclosed above, values 506 may be gathered for attributes 504.

For example, attribute 504A may be the sector of the customer for the respective customer account. Value 506A for attribute 504A may be public or private sector. Attribute 504B may be size of the customer. Value 506B for attribute 504B may include a number, such as 1000, 10,000, or 100,000, or may include a category or range for size. Attribute 504C may be the type of business of the customer. Value 506C for attribute 504C may one of the types of business, such as health care, services, legal, real estate, and the like. Attribute 504D may be the revenue of the customer. Value 506D for attribute 504D may be an amount of revenue in dollars or other currency, or a range or category for revenue. Attribute 504E may be loyalty, or how many service providers for the customer. Value 506E for attribute 504E may be a number of providers that the customer uses. For example, the customer may use multiple document management systems.

Customer intelligence layer 302 also includes engagement status 406. This module may provide a measurement of a level of engagement 408 by the customer of the respective customer account with a provider for document management system 100. Alternatively, document management system 100 may track the level of engagement 408 by the customer. For example, storage system 112 may track how many documents are uploaded and accessed by the customer.

Engagement status 406 also may provide level of engagement 408 of the customer with the current document management system provider in terms of purchasing history, satisfaction level, and any purchasing intentions expressed via the provider or within system 100. Engagement status 406 captures the dynamic characteristic of the customer based on their history with and within document management system 100. Engagement status 406 with level of engagement 408 combined with customer characteristics 402 and the actual usage metrics may feed into the development of the initial heuristics for a sales approach.

Referring to FIG. 5B, a table 508 of example levels of engagement is disclosed. Table 508 includes attributes 510 and values 512. Engagement status 406 may include attributes 510 and values 512 corresponding to each customer account. As disclosed above, values 512 may be tracked for attributes 510.

For example, attribute 510A may be the number of services used by the customer. Value 512A may be a number, such as 1, 2, 3, 4, and the like, for attribute 510A. Attribute 510B may be the cancellation record of the customer. Value 512B may be yes or no for attribute 510B. Attribute 510C may be the overall satisfaction of the customer. Value 512C may be poor, good, or excellent for the overall satisfaction. Attribute 510D may be the number of outstanding issues for the customer. Outstanding issues may be those issues at the time of the collection of customer market data 152 for engagement status 406 that are not resolved on behalf of the customer. Value 512D may be a number, such as 11, 12, or 13. Attribute 510E may relate to the account management relationship for the client. Value 512E for attribute 510E may be poor, good, or excellent. Attribute 510F may relate to an intention expressed for new features. Value 512F may be yes or no for attribute 510F.

Usage pattern 410 may be a module that provides usage metrics and usage pattern information 412. Usage metrics and usage pattern information 412 may be gathered from a historical database 414 of the respective customer account. Database 414 may be located in document management system 100. The data for information 412 may be generated automatically based on the data from customer accounts 154 that is stored in database 414 for the respective customers. Usage pattern 410 may differ from engagement status 406 in that it represents how often the customer uses document management system 100 as opposed a level of engagement with the system. Usage pattern 410 may indicate days of the week, or hours in the day, when the customer uses the document management system above or below average levels. For example, a medical clinic may use the system during business hours only and not at all during non-business hours; whereas a hospital may use it more heavily during day time but less so overnight. The usage pattern can also track document specific information such as number or size of documents uploaded using system 100 as disclosed above single versus bulk uploads, storage space used, and the like, to provide more detail about the demand pattern for the specific customer (as opposed to a typical customer in the industry segment).

Referring to FIG. 5C, a table 514 of example usage metrics and patterns is disclosed. Table 514 includes attributes 516 and values 518. Usage pattern 410 may include attributes 516 and values 518 corresponding to each customer account. As disclosed above, values 518 may be tracked for attributes 516.

For example, attribute 516A relates to the number of documents stored within storage system 112 or within document management system 100. Value 518A for attribute 516A may be number, such as 1000, or a range or category. Attribute 516B may relate to a frequency of access. Value 518B may be the number of documents accessed per day for attribute 516B. Attribute 516C may relate to storage usage ratio within document management system 100. Value 518C may be a designation, such as hot, warm, or cold.

Attribute 516D may relate to storage growth rate within document management system 100. Value 518D may be a level of growth rate, such as low, moderate, or high. Attribute 516E may relate to the monthly distribution of storage. Value 518E may be a number for the storage space utilized per month. Attribute 516F may relate to the ratio of frequent to infrequent users. Value 518F may be a level for the ratio, such as low, moderate, or high. Attribute 516G may relate to the average size of documents stored in storage system 112. Value 518G may be a number for the average size, such as 1 MB. Attribute 516H may relate to the document size trend. Value 518H for attribute 516H may be a trend level, such as increasing, decreasing, or the same.

Output from customer characteristics 402, engagement status 406, and usage pattern 410 is provided to components in other layers of customer intelligence platform 150. Thus, output from customer characteristics 402 and engagement status 406 is provided together as represented by A. Output from usage pattern 410 is provided as represented by B. Output from customer characteristics 402 and usage pattern 410 may be provided together as represented by C. Output from engagement status 406 to predictive analytics layer 306 may be represented by D.

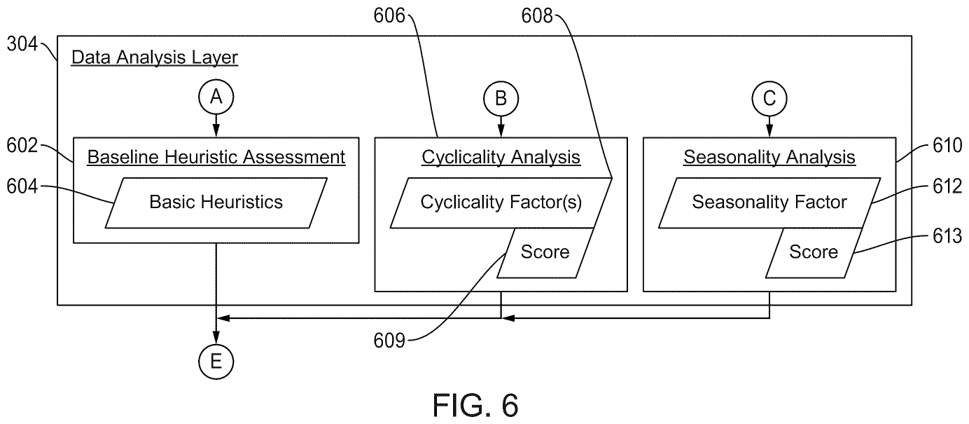

FIG. 6 depicts a block diagram of data analysis layer 304 of customer intelligence platform 150 according to the disclosed embodiments. Customer intelligence data from customer intelligence layer 302 is analyzed. Data analysis layer 304 includes three modules, baseline heuristic assessment 602, cyclicality analysis 606, and seasonality analysis 610.

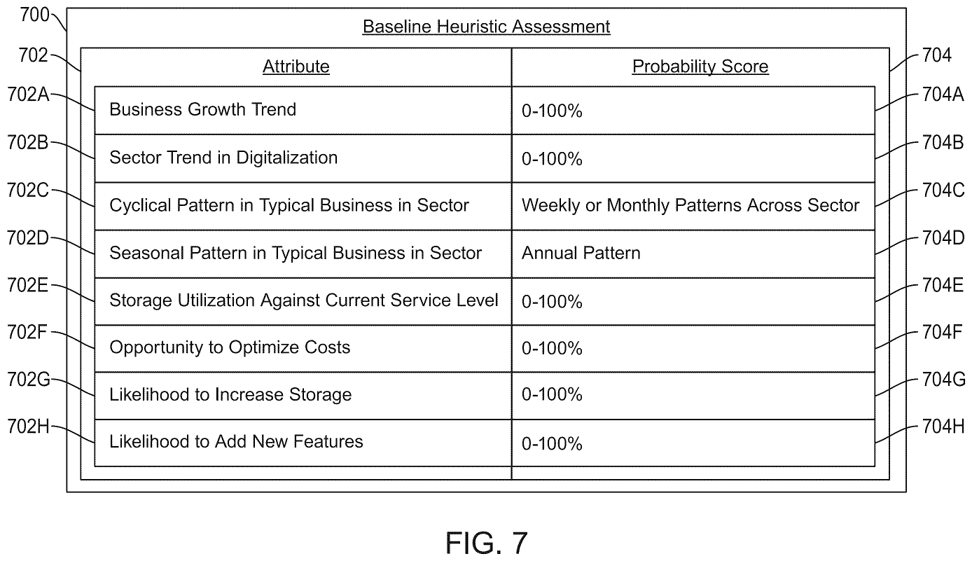

Baseline heuristics assessment 602 receives customer characteristics 402 and engagement status 406 as shown by A in FIG. 6. This module analyzes the gathered data from customer characteristics 402 and engagement status 406 to generate basic heuristics 604 for further analysis in predictive analytics layer 306. The output of baseline heuristics assessment 602 may be in tabular form as disclosed in FIG. 7. A usage probability score may be assigned to each attribute.

Cyclicality analysis 606 mines through the customer data received from usage pattern 410 as shown by B to determine cyclicality. If there is cyclicality, then cyclicality analysis 606 generates one or more cyclicality factors 608. Cyclicality may relate to usage over a period, such as a week. It may measure when activity occurs. For example, weekend usage for a customer may be slow. Thus, a cyclicality factor 608 may be that weekend usage is significantly lower than weekday usage. Further, cyclicality factor 608 may be assigned a probability score 609.

In some embodiments, cyclicality factors 608 may be defined for cyclicality analysis 606 and the probability scores assigned to the defined factors as being probable for that customer. For example, in reviewing the usage pattern data, the probability of the low weekend usage may have a probability score 609 of 80%. Several factors 608 may be defined having different scores 609. Cyclicality factors 608 along with the respective scores 609 may be provided with basic heuristics 604. In some embodiments, scores 609 may be treated as weights.

Seasonality analysis 610 mines through the customer data received from usage pattern 410 as well as customer characteristics 402 as shown by C to determine seasonality. If there is seasonality, then seasonality analysis 610 generates one or more seasonality factors 612. Seasonality may relate to factors impacting customer usage or behavior over different parts of the year. For example, a customer having a business related to Christmas may not have much activity during certain parts of the calendar year. A customer having a business related to preparing taxes may have specific needs in the spring to meet the demands of filing taxes. Thus, access and need for document management system 100 may be seasonal. Seasonality factor 612 may be assigned a probability score 613.

Seasonality factors 612 may be defined for all customers and a probability score 613 assigned to each factor, much like cyclicality factors 608. Seasonality factors 612 along with the respective scores 613 may be provided with basic heuristics 604. In some embodiments, scores 613 may be treated as weights for their respective factors.

Baseline heuristic assessment 602 with basis heuristics 604, cyclicality factors 608 and scores 609, and seasonality factors 612 and scores 613 are output from data analysis layer 304 to predictive analytics layer 306 as shown by E. FIG. 7 depicts a table 700 of an example baseline heuristic assessment 602 according to the disclosed embodiments.

Table 700 includes attributes 702 and probability scores 704. Attributes 702 and probability scores 704 are provided as output from data analysis layer 304. Attributes 702 may include attributes about the customer derived from customer market data 152 as processed by customer intelligence layer 302 and data analysis layer 304. For example, attribute 702A may relate to a business growth trend for the customer. Probability score 704A is a percentage between 0-100% that business growth will occur.

Attribute 702B may relate to a sector trend in digitalization. Based on information about the customer and its sector, the disclosed embodiments may determine probability score 704B between 0-100% that the sector is looking to trend to digitalization of its documents and have an increased need for document management system 100. Attribute 702C may relate to one or more cyclical patterns in a typical business in the sector. Attribute 702C may relate to cyclicality factors 608 disclosed above. Probability score 704C for attribute 702C may relate to the probabilities of weekly or monthly patterns across the sector for the customer.

Attribute 702D may relate to one or more seasonal patterns in a typical business in the sector. Attribute 702D may relate to seasonality factors 612 disclosed above. Probability score 704D for attribute 702D may relate to the probabilities of annual patterns for the customer. Attribute 702E may relate to storage utilization against current service level. Probability score 704E for attribute 702E may be between 0-100%.

For example, probability score for 702D is the probability that the customer would use the system at a certain level in a particular period of the year. So, for example, a tax firm may use the system heavily from March till May every year, less so in other months, a payroll tax processing firm may use it at the end of every two weeks or the month, and the like. So, the seasonal pattern captured by the heuristic attribute in 702D is March->May high usage, or monthly or bi-monthly usage spike, respectively. Similarly, storage utilization for 702E is another heuristic attribute providing probabilistic score of the utilization level of storage space provided at the current service level (service level being the tier in pricing plan which comes with a certain amount of storage space) at a given point in time,

This score is then used to alert the customer and the account manager to adjust their service level (or automatically adjust it if the system is so specified) if the utilization level is predicted to be >80%, for example. Each service level has different amount of storage allocation or API upload limits (if API is used to upload documents rather than the Web Client) which may can be monitored and adjusted periodically based on a demand (usage) probability score reflected in the disclosed embodiments.

Attribute 702F may relate to the opportunity to optimize costs. This attribute may relate to the likelihood that the customer will look to optimize costs for services within document management system 100. Probability score 704F for attribute 702F may be between 0-100% that there is such an opportunity. Attribute 702G may relate to the likelihood to increase storage within document management system 100. Probability score 704G for attribute 702G may be between 0-100% that there is such a likelihood. Attribute 702H may relate to the likelihood to add new features in document management system 100 to the respective customer account. Probability score 704H for attribute 702H may be between 0-100% that there is such a likelihood. Attributes 702G and 702H may be some of the more important attributes in table 702.

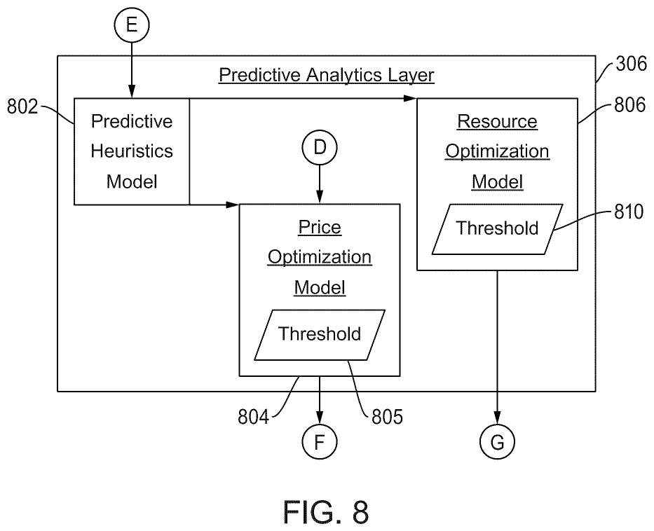

FIG. 8 depicts a block diagram of predictive analytics layer 306 of customer intelligence platform 150 according to the disclosed embodiments. Predictive analytics layer 306 receives output from data analysis layer 304 as represented by E. Predictive analytics layer 306 includes predictive heuristics model 802, price optimization model 804, and resource optimization model 806. Models 802, 804, and 806 may be machine learning or artificial intelligence (AI) models that are trained to provide output in the form of probabilities or predictions based on the input data.

Predictive analytics layer 306 implements intelligent processing of the analyzed data in the form of table 700, cyclicality factors 608 having scores 609, and seasonality factors 612 having scores 613. Predictive analytics layer 306 may generate the best probability of a successful plan and pricing point for a customer. The layer also may predict if there a decline in usage or the possibility of losing the customer. The sales team from document management system 100 may then provide specific retention incentives to the customer. Each customer for each customer account 154 may be put through predictive analytics layer 306.

Predictive heuristics model 802 receives the output from data analysis layer 304. For example, basic heuristics 604 in the form of table 700 as well as the data for cyclicality factors 608 and seasonality factors 612. Predictive heuristics model 802 may perform recursive statistical analysis with the received data to identify one or more best courses of actions 316 for a respective customer.

In some embodiments, predictive heuristics model 802 may implement weighted linear regression to generate predictive heuristics for the customer. Model 802 may assign different weights to data points within the model. This feature may be useful when some data points are more reliable than others. Model 802 may apply weights to the input data and data between the hidden nodes within the model. Model 802 may be trained with the appropriate weights to apply to the data from data analysis layer 304. The disclosed embodiments may evaluate model performance using appropriate metrics that account for weighting schemes, then modify model 802 based on these results.

For predictive heuristics model 802, the disclosed embodiments may use a ML model to analyze the data. In alternate embodiments, a linear regression analysis tool may be implemented for strategy identification based on the score derived from probability curves. Linear regression may be performed on known data sets. In some embodiments, predictive heuristics model 802 performs recursive statistical analysis with the pre-processed data to identify the best pricing plan for a given customer.

Predictive heuristics model 802 may use weighted linear regression to predict values for use by price optimization model 804 and resource optimization model 806 for the various values provided in the input data to the predictive heuristics model. Weights may be applied to one or more input variables, such as attributes 702 of baseline heuristic assessment 700, cyclicality factor 606, or seasonality factor 612. These weights may be adjusted through use of predictive heuristics model 802 in developing pricing points and plans to recommend to customers.

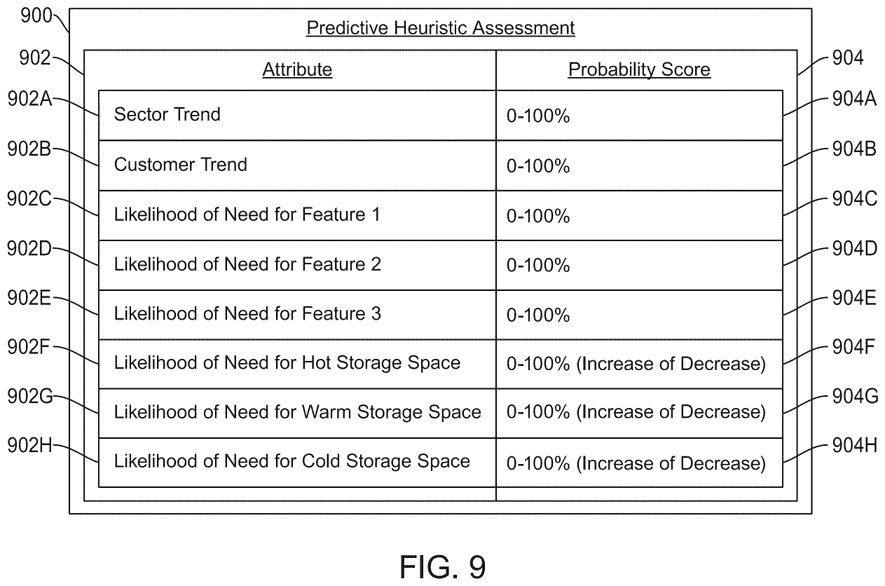

Each feature within predictive heuristics model 802 is scored based on likely customer needs. FIG. 9 depicts a table 900 of a predictive heuristic assessment having attributes 902 and probability scores 904 according to the disclosed embodiments. Table 900 may be in the form of a weighted probability distribution curve. Attribute 902A may relate to a sector trend identified by model 802. One or more sector trends may be identified. Probability score 904A for attribute 902A may be between 0-100% that the identified sector trend applies to the customer.

For example, a tax office will have typically a higher probability of usage in March to May period in the USA; in July to October in Australia, etc. Insurance companies would have seasonally high usage pattern during hurricane season. Colleges would have seasonally higher usage pattern in fall and winter semesters than spring and summer. Vacation industry including hotels and resorts would have higher usage pattern during school holidays. Etc.

Document management system 100 may be provided demand pattern data based on sectors for input into predictive heuristics.

Attribute 902B relates to a customer trend identified by model 802. One or more customer trends for the customer may be identified. Probability score 904B for attribute 902B may be between 0-100% that the customer trend applies to the customer. Attribute 902C relates to the likelihood of a need for a first feature of document management system 100 for the customer. Probability score 904C may be between 0-100% that the customer will need the first feature. Attribute 902D relates to the likelihood of a need for a second feature of document management system 100 for the customer. Probability score 904D may be between 0-100% that the customer will need the second feature. Attribute 902E relates to a likelihood of a need for a third feature of document management system 100 for the customer. Probability score 904E may be between 0-100% that the customer will need the third feature.

For example, an industry trend may be what a typical customer in the same industry is likely to do while a customer trend is what a customer has shown through their usage pattern as disclosed above (applicable only for existing long-term customers). For example, the customer may operate in limited hours, say, only 3 days rather than 5 days a week; or may operate extended hours, say 7 days a week, 12 hours day, during high seasonal demand. Thus, a tax accountant may decide to offer their customers longer in-office visit window. For an online business this could also happen. For example, an on-line store may offer special discounts every year at certain times, over and above what other (sector typical) stores may do, resulting in more receipts and invoices requiring to be stored. Therefore, the purpose of tracking the customer trend is to ensure that sufficient attention has been paid to their specific needs of the customer before suggesting a service level modification, which can be counterproductive from a CRM perspective.

A probability score for the features provide the likely need for that feature. Feature could be storage space (various types—hot/warm/cold), scanned document uploads requiring OCR feature, API uploads (uploading via the API versus web client), signature requests (requiring DocuSign calls), and the like. The probability score for the attribute allows the system resources to be allocated at the optimal level with corresponding adjustment to customer's service level or pricing plan.

Attribute 902F relates to the likelihood of a need for hot storage space for the customer. Probability score 904F may be between 0-100% and indicate whether this percentage is an increase or decrease for the need. Attribute 902G relates to the likelihood of a need for warm storage space for the customer. Probability score 904G may be between 0-100% and indicate whether this percentage is an increase or decrease for the need. Attribute 902H relates to the likelihood of a need for cold storage space for the customer. Probability score 904H may be between 0-100% and indicate whether this percentage is an increase or decrease for the need.

For example, hot storage is for the storage of documents that require frequent access, such as draft documents, form templates, documents in progress for signature validation, and the like. They are stored in a costlier hot storage service offer by cloud service providers. Warm storage is for relatively less accessed documents, such as receipts or invoices, filed tax returns, medical images, and the like. Cold storage is for long term storage for record keeping purposes (such as contracts retained for legal hold). These may be the cheapest storage from a systems perspective. If the customer usage pattern is known to be rare for certain documents, then document management system 100 can risk them putting away in cold storage to increase profitability or provide competitive pricing.

Predictive heuristics model 802 also considers one or more cyclicality factors 608 and seasonality factors 612. These factors have probability scores associated therewith. These factors and scores are provided with the input to model 802.

For example, cyclicality factors may be usage patterns in cycles. The cycles can be time of day, day of week, and the like. for document uploads, API usage, storage utilization and the like. The forward-looking attributes are enumerated in probabilistic terms because no one can say for certain. For example, 60% probability of 100 document uploads on Monday may apply in February, but 80% probability of 100 document uploads may apply in July. The cyclicality factor is used to form baseline heuristics providing what a typical customer in the industry segment is likely to need from document management system 100. When a combined customer usage pattern, which is derived from historical metrics collected by a long-term customer, the disclosed embodiments can generate a probability score to predict future usage requirements. For new customers, the disclosed embodiments may ignore the customer usage pattern because it is non-existent.

Referring back to FIG. 8, the predictive heuristic assessment as disclosed above is provided to price optimization model 804. Price optimization model 804 also is a machine learning or AI model used to identify the best strategy for handling actions 316 with the customer based on heuristics feed when a defined threshold 805 is met. Price optimization model 804 receives the output from predictive heuristics model 802 as well as engagement status 406 from customer intelligence layer 302 as represented by D. Price optimization model 804 also may receive output from customer characteristics 402 and usage pattern 410.

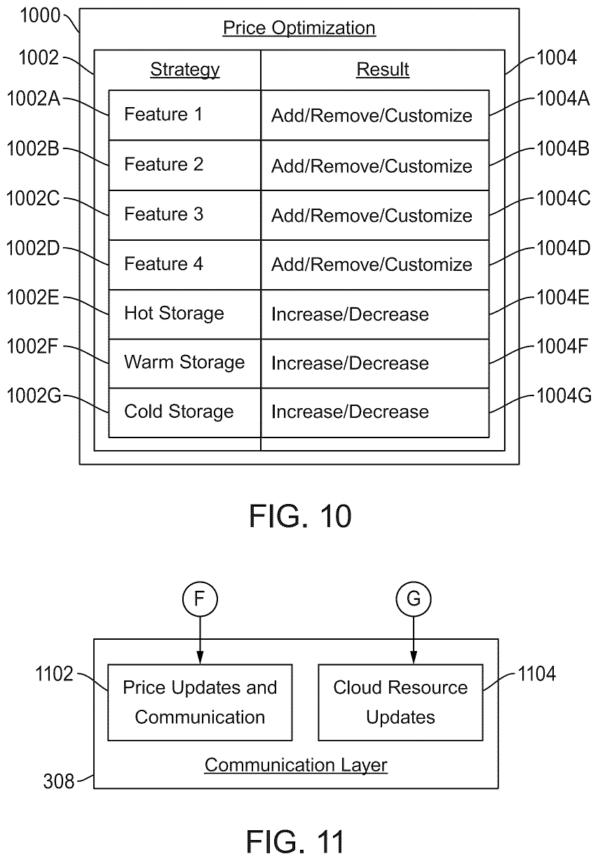

For example, price optimization model 804 may receive the actions to be taken shown by attributes 902 to determine whether these actions should be taken. The results may be provided in table 1000, as disclosed by FIG. 10. FIG. 10 depicts a table 1000 of the strategy identification having strategies 1002 and results 1004 according to the disclosed embodiments. Table 1000 includes strategies 1002 related to actions 316 to be taken as identified by predictive heuristics model 802. The predicted values for these strategies are compared to threshold 805 to determine whether the action for the strategy should be taken.

Strategy 1002A may relate to a first feature provided by document management system. The first feature may be related to the first feature noted in attribute 902C. Result 1004A indicates whether the first feature should be added, removed, or customized with regards to the respective customer. This same analysis may be performed for strategy 1002B for the second feature along with result 1004B, strategy 1002C for the third feature along with result 1004C, and strategy 1002D for a fourth feature along with result 1004D.

Price optimization model 804 may input the data and information disclosed above to identify the features of document management system 100 to be presented to the customer along with probability scores that the customer will accept the features. Model 804 compares these scores to threshold 805 to add, remove, or customize the features. Threshold 805 may provide a check that is adjustable so that the sales team of document management system 100 is not wasting its time. A high threshold may indicate that this customer is only to be approached with strategies that are likely to result in new engagements. A low threshold may indicate that the customer should be approached to engender new business.

Strategy 1002E may relate to hot storage for the customer within system 100. Result 1004E may indicate whether to approach the customer to increase or decrease the amount of hot storage for the customer. Strategy 1002F may relate to warm storage for the customer within system 100. Result 1004F may indicate whether to approach the customer to increase or decrease the amount of warm storage for the customer. Strategy 1000G may relate to cold storage for the customer within system 100. Result 1004F may indicate whether to approach the customer to increase or decrease the amount of cold storage for the customer.

The strategy identification results of table 1000 may be provided to target audience identification model 806. Model 806 may determine how the customer should be approached with the recommendations provided by strategy identification model 804. Target audience identification model 806 may identify specific users who are likely to be most receptive to suggestions based on previous subscription history or usage pattern. Target audience identification model 806 may provide predictions of whether the strategies identified in table 1000 will be acceptable to different audiences with the customer organization.

Based on results 1004 for strategies 1002, price optimization model 804 determines a price point and subscription plan for the customer. The disclosed embodiments may analyze the need for the different features by the customer to arrange an optimal plan and price point. For example, feature 2 and 4 may be added based on the results in table 1000. Features 1 may be removed and feature 3 may be left alone. Thus, price optimization model 804 may use features 2, 3, and 4 in determining actions 316 to be taken, namely which subscription plan and a price point for the subscription plan to propose for a customer. Price optimization model 804 may consider strategies 1002 proposed by the model to determine actions 316.

Threshold 805 may be used to trigger when the optimum price point and subscription plan should be identified. Threshold 805 may relate to a resource utilization forecast for the customer within document management system 100 based on strategies 1002 determined by price optimization model 804. For example, if the features probably to be used by a customer result in a need for over 100 actions per month, then threshold 805 may trigger the determination of a plan and price point for the customer, or a change in its current situation.

Predictive analytics layer 306 also includes resource optimization model 806. Resource optimization model 806 may operate much like price optimization model 804, except that it determines the optimum cloud resources to be allocated based on the forecasted usage pattern of the customer. Resource optimization model 806 also may use a threshold 810 based on resource utilization forecast resulting from features to be used by the customer in document management system 100.

Resource optimization model 806 also may generate its own table 1000 or use the table generated by price optimization model 804, which includes strategies 1002 and results 1004 of the model after it receives predictive heuristic assessment 900. Based on these results, the disclosed embodiments can determine the resources to allocate to the customer within document management system 100.

For example, resource optimization model 806 can determine the probability that the customer will need storage at different levels and allocate the amount of storage to the customer along with the price point for such storage. This feature prevents the allocation of storage to customers that do not need it, or not allocating enough storage to customers based on customer market data 152 and the predictive heuristics process disclosed above.

FIG. 11 depicts a block diagram of communication layer 308 of customer intelligence platform 150 according to the disclosed embodiments. Communication layer 308 enables the communication pathway to the customer and the service provider for document management system 100. Communication layer 308 may be an action and presentation layer using features within document management system 100 such as user interface 320. User interface 320 may display a variety of dashboards, as disclosed below. Communication layer 308 may include price updates and communication 1102 and cloud resource updates 1104. Actions 316 based on the strategies identified by predictive analytics layer 306 may be presented in representations layer 308.

Price updates and communication 1102 may receive output from price optimization model 804 as represented by F. A customer dashboard may display plan and price recommendations for the customer through user interface 320. Price updates and communication 1102 may be a module that makes the updates to the subscription and pricing plans for the customer. It also communicates the changes to the customer and their account manager. These features may be implemented to execute automatically within document management system 100.

Cloud resource updates 1104 may receive output from resource optimization model 806 as represented by G. This module may send the scaling message for cloud resource allocation levels to the cloud service provider to change cloud resources for the forecasted period. The communication also may be implemented using user interface 320.

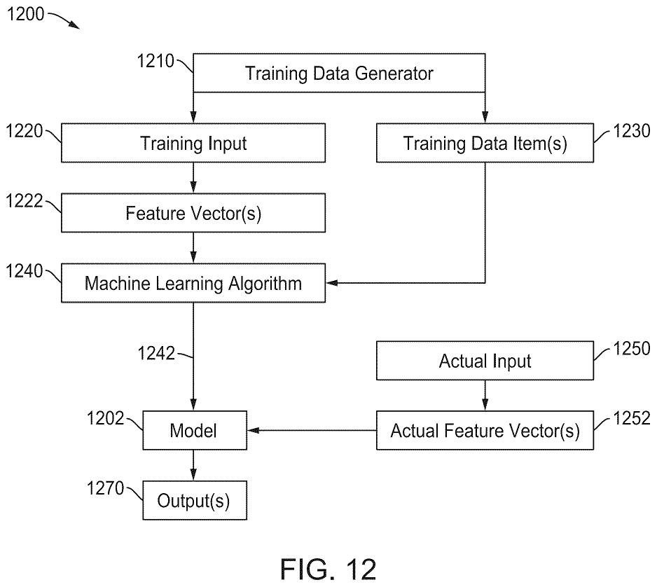

FIG. 12 depicts a block diagram of a supervised learning pipeline 1200 for a model 1202 as used by predictive analytics layer 306 according to the disclosed embodiments. Model 1202 may pertain to predictive heuristics model 802, price optimization model 804, or resource optimization model 806. Each model is generated and trained using supervised learning pipeline 1200. For brevity, model 1202 is used herein as opposed to disclosing the supervised learning process for each model 802, 804, and 806 separately.

Supervised learning pipeline 1200 includes training data generator 1210, training input 1220, one or more feature vectors 1222, one or more training data items 1230, machining learning algorithm 1240, actual input 1250, one or more actual feature vectors 1252, model 1202, and one or more predictive date field outputs 1270. Part or all of supervised learning pipeline 1200 may be implemented by executing software for part or all of supervised learning pipeline 1200 using one or more processors 114 or other components within storage system 112 or one or more processors 310 within customer intelligence platform 150.

In operation, supervised learning pipeline 1200 may involve two phases: a training phase and a prediction phase. The training phase may involve machine learning algorithm 1240 learning one or more tasks related to detecting attributes or strategies for use by the model. The prediction phase may include model 1202, which is a trained version of machine learning algorithm 1240 and makes predictions to accomplish one or more tasks for determining features along with probability scores for recommendations to a customer. In some embodiments, machine learning algorithm 1240 or model 1202 may include one or more artificial neural networks (ANNs), deep neural networks, convolutional neural networks (CNNs), recurrent neural networks, support vector machines (SVMs), Bayesian networks, genetic algorithms, linear classifiers, non-linear classifiers, algorithms based on kernel methods, logistic regression algorithms, linear discriminant analysis algorithms, or principal components analysis algorithms.

During the training phase of supervised learning pipeline 1200, training data generator 1210 may generate training input 1220 and training data item(s) 1230. Training input 1220 may be processes to determine one or more feature vectors 1222. In some embodiments, training input 1220 may be preprocessed. For example, for each model within predictive analytics layer 306, training input 1220 may be preprocessed to the output or information received from the applicable module within customer intelligence platform 150. The tables, factors, scores, attributes, strategies, results, and the like may be used as part of training input 1220. In some embodiments, training data generator 1210 is not used to generate training input 1220 or training data items(s).

Feature vector(s) 1222 may be provided to machine learning algorithm 1240 to learn one or more tasks for determining a probability or condition for an attribute or a result for a strategy. After performing the one or more tasks, machine learning algorithm 1240 may generate one or more outputs 1242 based on feature vector(s) 1222 and, optionally, training data items 1230.

During training, training data items 1230 may be used to make an assessment of the outputs 1242 of machine learning algorithm 540 for accuracy. Machine learning algorithm 1240 may be updated based on this assessment. Training of machine learning algorithm 1240 is considered to be trained to perform the one or more tasks for providing a probability for an attribute or a result for a strategy. Once trained, machine learning algorithm 1240 may be considered to be model 1202. In other words, model 1202 may be generated from the training of machine learning algorithm 1240. In some embodiments, machine learning algorithm 1240 also is known as a model.

During the prediction phase of supervised learning pipeline 1200, actual input 1250 may be used to generate one or more actual feature vectors 1252. In some embodiments, some of all of actual input 1250 includes one or more forms of data disclosed above. Actual input 1250 may be provided to model 1202 via actual feature vector(s) 1252. Model 1202 may generate one or more outputs, such as predictions or probabilities, based on actual input 1250. The outputs of model 1202 may be provided as outputs 1270. Outputs 1270 are provided to the next module within predictive analytics layer 306 or output to communication layer 308.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for managing customers accessing a customer service intelligence platform of a document management system, the method comprising:
collecting customer data for a customer account within the document management system, wherein the customer data includes a set of customer characteristics, an engagement status of the customer, and at least one usage pattern of the customer;
analyzing the customer data to generate a baseline heuristics assessment that includes at least one cyclicality factor and at least one seasonality factor, wherein each of the at least one cyclicality factor is assigned a probability score and each of the at least one seasonality factor is assigned a probability score;
applying a predictive heuristics model to the baseline heuristic assessment, the probability score of the at least one cyclicality factor, and the probability score of the at least one seasonality factor to identify or generate a plurality of resource utilizations applicable to the customer account, wherein each of the plurality of resource utilizations is assigned a probability score;
applying a resource optimization model to the plurality of resource utilizations from the predictive heuristics model and the customer data collected within the document management system to identify or select a resource utilization to provide to the customer account, wherein the resource utilization is assigned a score by the resource optimization model;
determining whether the score for the resource utilization is equal to or greater than a defined threshold for the customer account; and
recommending through the document management system that the resource utilization be applied to the customer account.

2. The method of claim 1, wherein the resource utilization includes a cloud resource utilization for the customer account.

3. The method of claim 1, wherein the resource utilization includes a forecasted level of service.

4. The method of claim 1, wherein applying the predictive heuristics model includes assigning a weight to each of the at least one cyclicality factor and a weight to each of the at least one seasonality factor.

5. The method of claim 1, wherein the predictive heuristics model is a weighted linear regression model to generate a probability curve.

6. The method of claim 1, further comprising using a cyclicality analysis module to generate the at least one cyclicality factor.

7. The method of claim 1, further comprising using a seasonality analysis module to generate the at least one seasonality factor.

8. A customer service intelligence platform of a document management system, the platform comprising:
a processor and a memory connected to the processor, the memory storing instructions that, when executed on the processor, configures the platform to perform operations comprising
collecting customer data for a customer account within the document management system, wherein the customer data includes a set of customer characteristics, an engagement status of the customer, and at least one usage pattern of the customer;
analyzing the customer data to generate a baseline heuristics assessment that includes at least one cyclicality factor and at least one seasonality factor, wherein each of the at least one cyclicality factor is assigned a probability score and each of the at least one seasonality factor is assigned a probability score;
applying a predictive heuristics model to the baseline heuristic assessment, the probability score of the at least one cyclicality factor, and the probability score of the at least one seasonality factor to identify or generate a plurality of resource utilizations applicable to the customer account, wherein each of the plurality of resource utilizations is assigned a probability score;
applying a resource optimization model to the plurality of resource utilizations from the predictive heuristics model and the customer data collected within the document management system to identify or select a resource utilization to provide to the customer account, wherein the resource utilization is assigned a score by the resource optimization model;
determining whether the score for the resource utilization is equal to or greater than a defined threshold for the customer account; and
recommending through the document management system that the resource utilization be applied to the customer account.

9. The customer service intelligence platform of claim 8, wherein the resource utilization includes a cloud resource utilization for the customer account.

10. The customer service intelligence platform of claim 8, wherein the resource utilization includes a forecasted level of service.

11. The customer service intelligence platform of claim 8, wherein the operation of applying the predictive heuristics model includes assigning a weight to each of the at least one cyclicality factor and a weight to each of the at least one seasonality factor.

12. The customer service intelligence platform of claim 8, wherein the predictive heuristics model is a weighted linear regression model.

13. The customer service intelligence platform of claim 8, further comprising a cyclicality analysis module to generate the at least one cyclicality factor.

14. The customer service intelligence platform of claim 8, further comprising a seasonality analysis module to generate the at least one seasonality factor.

15. A non-transitory computer-readable medium having stored thereon processor-executable instructions for performing operations comprising:
collecting customer data for a customer account within the document management system, wherein the customer data includes a set of customer characteristics, an engagement status of the customer, and at least one usage pattern of the customer;
analyzing the customer data to generate a baseline heuristics assessment that includes at least one cyclicality factor and at least one seasonality factor, wherein each of the at least one cyclicality factor is assigned a probability score and each of the at least one seasonality factor is assigned a probability score;
applying a predictive heuristics model to the baseline heuristic assessment, the probability score of the at least one cyclicality factor, and the probability score of the at least one seasonality factor to identify or generate a plurality of resource utilizations applicable to the customer account, wherein each of the plurality of resource utilizations is assigned a probability score;
applying a resource optimization model to the plurality of resource utilizations from the predictive heuristics model and the customer data collected within the document management system to identify or select a resource utilization to provide to the customer account, wherein the resource utilization is assigned a score by the resource optimization model;
determining whether the score for the resource utilization is equal to or greater than a defined threshold for the customer account; and
recommending through the document management system that the resource utilization be applied to the customer account.

16. The non-transitory computer-readable medium of claim 15, wherein the resource utilization includes a cloud resource utilization for the customer account.

17. The non-transitory computer-readable medium of claim 15, wherein the resource utilization includes a forecasted level of service.

18. The non-transitory computer-readable medium of claim 15, wherein the operation of applying the predictive heuristics model includes assigning a weight to each of the at least one cyclicality factor and a weight to each of the at least one seasonality factor.

19. The non-transitory computer-readable medium of claim 15, wherein the operations further include using a cyclicality analysis module to generate the at least one cyclicality factor.

20. The non-transitory computer-readable medium of claim 15, wherein the operations further include using a seasonality analysis module to generate the at least one seasonality factor.
